(19) United States
(12) Patent Application Publication
(10) Pub. No.: US 2021/0279776 A1
(43) Pub. Date: Sep. 9, 2021

(54) TECHNIQUES AND APPARATUSES FOR INCREASING THE FREQUENCY OF CUSTOMER RATING AND REVIEW OF BUSINESSES ONLINE

(71) Applicant: Engage Technologies Group, Inc., Boise, ID (US)

(72) Inventors: Michael Alfred Boerner, Boise, ID (US); Isaac James Strafuss, Meridan, ID (US); Andrew Robert Mason, Boise, ID (US)

(21) Appl. No.: 17/196,469

(22) Filed: Mar. 9, 2021

Related U.S. Application Data
(60) Provisional application No. 62/987,281, filed on Mar. 9, 2020.

(51) Int. Cl. G06Q 30/02; G06K 19/07; G06K 19/06

(52) U.S. Cl. CPC G06Q 30/0282; G06K 19/06037; G06K 19/0723

(57) ABSTRACT

This publication describes techniques and apparatuses directed at increasing the frequency of customer ratings and reviews of businesses online. The disclosed techniques and apparatuses utilize shortened direct links to an online business review page and a radio tag to increase the frequency of customer ratings and reviews of businesses online.

### CROSS-REFERENCE TO RELATED APPLICATION

This application claims the benefit of U.S. Provisional Application No. 62/987,281, filed Mar. 9, 2020, the disclosure of which is incorporated by reference.

### BACKGROUND

Customers frequently leave business ratings, reviews, and feedback (collectively an “online business review”) through use of an online service. Online business reviews are useful to customers, enabling them to make purchasing decisions based on the shared experiences of other customers. Online business reviews are also helpful for businesses, enabling them to receive customer feedback and monitor their online reputation.

Online business reviews are frequently generated automatically and are time-delayed from the “height of delight” (emotional) moment. Often times, the online services include filters that are time-consuming for a customer to navigate and tend to eliminate the bad reviews that can skew the authenticity. For this and other reasons, there can be considerable push-back from customers when asked to leave an online review for a business. Current techniques for increasing the frequency of customer ratings and reviews of businesses online fail to address these problems because they are not able to capture the emotional response from a customer immediately following the customer's interaction with the business (e.g., service, procedure, transaction).

### SUMMARY OF THE DISCLOSURE

This document describes techniques and apparatuses directed at increasing the frequency of customer ratings and reviews of businesses online.

In an aspect of a method implemented by a computing device directed at increasing the frequency of customer ratings and reviews of businesses online, business identification information identifying a business is received. The computing device determines, utilizing the business identification information, a Uniform Resource Locator (URL) address associated with an online business review page for the identified business and generates a short link URL address for the URL address. The short link URL address is shorter than the URL address. The computing device establishes a connection with a radio tag and writes the short link URL address to the radio tag.

In another aspect of a method implemented by a computing device directed at increasing the frequency of customer ratings and reviews of businesses online, business identification information identifying a business is received. The computing device determines, utilizing the business identification information, a URL address associated with an online business review page for the identified business and generates a short link URL address for the URL address. The short link URL address is shorter than the URL address. A display is then generated. A connection is established with an NFC tag, and the short link URL address is written to the NFC tag. The NFC tag is attached to the display.

The following description and the referenced drawings provide illustrative examples of the techniques and apparatuses. As such, the examples discussed herein are merely exemplary in nature and are not intended to limit the scope of the techniques and apparatuses or their protection in any manner Rather, the description and illustration of these examples serve to enable a person of ordinary skill in the relevant art to practice the techniques and apparatuses. Additional understanding of the techniques and apparatuses for increasing the frequency of customer ratings and reviews of businesses online can be gained by reviewing the detailed description, presented below, and the referenced drawings.

### BRIEF DESCRIPTION OF THE DRAWINGS

The details of one or more aspects of techniques and apparatuses directed at increasing the frequency of customer ratings and reviews of businesses online are described in this document with reference to the following drawings:

FIG. 1 illustrates an example environment in accordance with the techniques and apparatuses of this disclosure;

FIG. 2 illustrates a second example environment in accordance with the techniques and apparatuses of this disclosure;

FIG. 3 illustrates a third example environment in accordance with the techniques and apparatuses of this disclosure;

FIG. 4 illustrates an example method in accordance with the techniques and apparatuses of this disclosure;

FIG. 5 illustrates another example method in accordance with the techniques and apparatuses of this disclosure; and

FIG. 6 illustrates a further example method in accordance with the techniques and apparatuses of this disclosure.

### DETAILED DESCRIPTION

### Overview

This document describes techniques and apparatuses for increasing the frequency of customer ratings and reviews of businesses online. One or more of the techniques (e.g., methods) and apparatuses may be computer-implemented. The techniques and apparatuses simplify the process of receiving customer ratings and reviews of businesses online. By doing so, in some cases, the techniques may increase the frequency of customer ratings and reviews of businesses online.

The described techniques and apparatuses can be used in any operatory, reception/front desk area, office, etc.—any place that could be the last touch for a user, customer, patient, client, or the like (collectively “customer”). The techniques and apparatuses may be useful to any individual or company (herein, the “entity”) whose online reputation could benefit from receiving online business reviews via an online business review service. The techniques and apparatuses may be performed by the entity or on behalf of the entity, for example, by a third-party service provider. This is just a single example of how the described techniques and apparatuses may be utilized to increase the frequency of customer ratings and reviews of businesses online. Additional examples are described throughout this document.

### Operating Environments

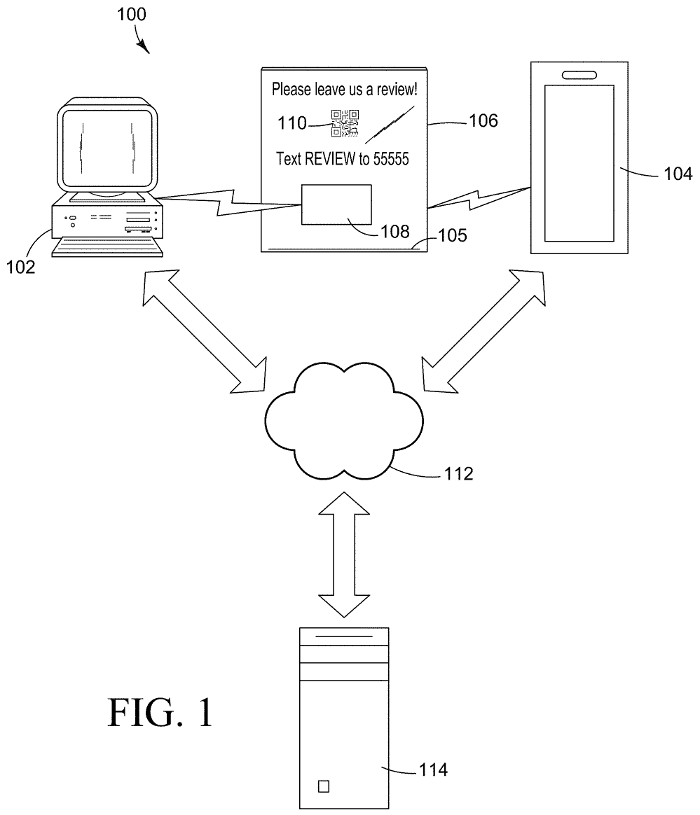

FIG. 1 illustrates an example environment 100 in which techniques and apparatuses for increasing the frequency of customer ratings and reviews of businesses online may be implemented. The example environment includes a first computing device 102, a second computing device 104, a display 106, machine-readable code (e.g., radio tag 108, optical machine-readable code 110), a communications network 112, and a server computer 114.

In the example environment 100, the first computing device 102 performs one or more techniques described in this document to generate the display 106 and/or the first computing device 102 may access a communications network 112 to perform one or more of the techniques described. The display 106 includes the machine-readable code. The display 106 may be one of a printed display or a digital display that is displayed in an information display system 105. In FIG. 1, the information display system 105 is a counter-top display holder and a printing process is used to generate a printed display 106 held by the information display system 105. The printed display 106 may be generated by a printing process. In another aspect, the information display system 105 is an electronic display and the display 106 is a digital display of the information display system 105.

The machine-readable code associated with the display 106 and/or the information display system 105 may include a radio tag 108. Examples of radio tags 108 include radio-frequency identification (RFID) tags and near-field communication (NFC) tags. An NFC tag is a passive data store that can be read and, under some circumstances, written to by an NFC-enabled computing device. The radio tag 108 may include an application (e.g., an NFC tag may include an NFC application) programmed with a URL address and/or other information (e.g., a query string embedded within a URL). In aspects, the NFC tag is programmed to output a URL address for directing a customer to a web address so that when a customer taps the NFC tag with their NFC-enabled computing device (e.g., smartphone), the computing device opens the URL address (e.g., one or more online business review submission pages) in a browser or application of the computing device.

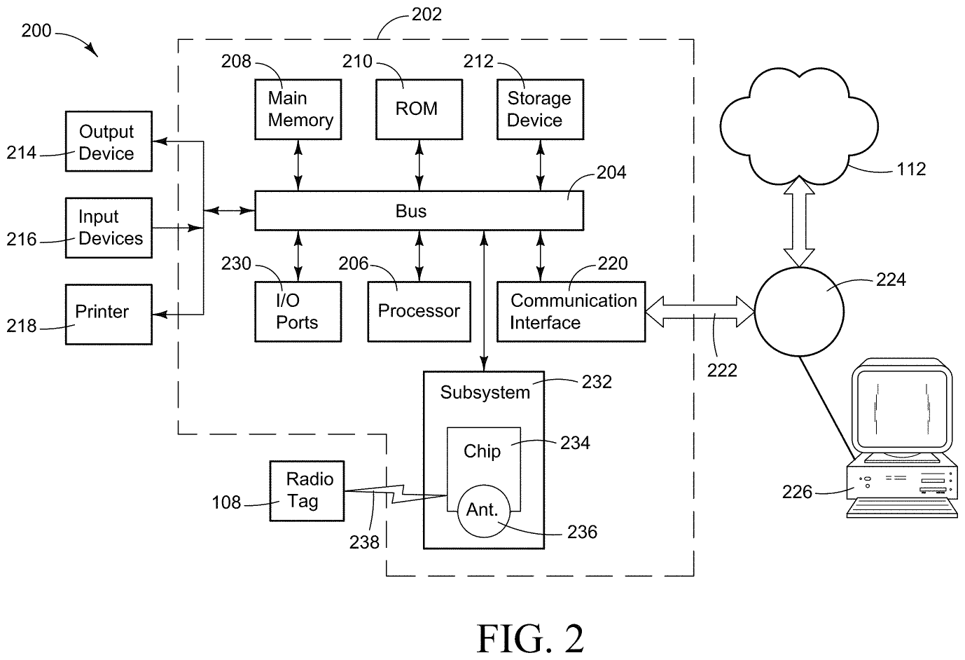

A computing system 202, shown in FIG. 2, may establish a connection (e.g., a wireless connection) with the radio tag 108 (e.g., NFC tag) and program the radio tag 108 to output the URL address. A software tool (e.g., NFC Tools for Desktop) may be utilized to program the NFC tag.

A radio tag 108 may be associated with the information display system 105 and/or the display 106. In a first example, the radio tag 108 is embedded into a label (e.g., a self-adhesive sticker) applied to the information display system 105 or the display 106, for example, directly behind a printed NFC logo or other indicia. In a second example, the radio tag 108 is embedded into the display 106 (e.g., a smart poster) utilized as a part of the information display system 105. In a third example, the radio tag 108 is attached to the display 106 utilized as part of the information display system 105. In another example, the second computing device 104 is an NFC-capable mobile phone including a radio tag reader (e.g., an NFC reader). Upon the customer placing the device 104 near the radio tag 108 or tapping the device 104 on the display 106 or radio tag 108, a programmed action is taken. For example, a web browser on the second computing device 104 may open, and the web browser of the second computing device 104 may utilize a communications network 112 to causing a website served on a server computer 114 to be displayed on device 104. In aspects, the website displayed may be a website presenting a survey to a customer for entering an online business review for a business.

The machine-readable code associated with the display 106 may include an optical machine-readable code 110. In aspects, an optical machine-readable code 110 may be a barcode, such as a QR code, which includes a URL address and/or other information (e.g., a query string embedded within a URL address). The second computing device 104 (e.g., customer's cell phone) is configured to access the machine-readable code to perform an action. For example, the second computing device 104 may be a mobile phone configured to use a camera to read the optical machine-readable code 110. Upon scanning the optical machine-readable code 110 using the camera, a programmed action is taken. For example, a web browser on the second computing device 104 may open, and the web browser of the second computing device 104 may utilize a communications network 112 to cause a website served on a server computer 114 to be displayed on device 104. In aspects, the website displayed may be a website presenting a survey to a customer for entering an online business review for a business.

FIG. 2 illustrates an example environment 200 including computer system 202, upon which techniques and apparatuses for increasing the frequency of customer ratings and reviews of businesses online may be implemented. The computer system 202 may be any one of a personal computer system, a work station computer system, a laptop computer system, an embedded controller system, a microprocessor-based system, a digital signal processor-based system, a hand-held device system, a cell phone system, a wireless system, a wireless networking system, etc. For example, the computer system 202 may include one or more of the first computing device 102 or the second computing device 104.

The computer system 202 includes a bus 204 or other communication mechanism for communicating information and a processor 206 coupled with the bus 204 for processing the information. The computer system 202 also includes a main memory 208, such as a random access memory (RAM) or other dynamic storage device (e.g., dynamic RAM (DRAM), static RAM (SRAM), synchronous DRAM (SDRAM), flash RAM), coupled to bus 204 for storing information and instructions to be executed by processor 206. Main memory 208 may be used for storing temporary variables or other intermediate information during the execution of instructions to be executed by processor 206. The computer system 202 may further include a read-only memory 210 (ROM 210) or other static storage device (e.g., programmable ROM (PROM), erasable PROM (EPROM), and electrically erasable PROM (EEPROM)) coupled to bus 204 for storing static information and instructions for processor 206. A storage device 212 (e.g., magnetic disk, optical disk) may be provided and coupled to bus 204 for storing information and instructions. The computer system 202 includes a computer-readable medium (CRM), which includes any suitable memory or storage device (e.g., main memory 208, ROM 210, storage device 212).

The computer system 202 also includes input/output ports 230 to couple the computer system 202 to external devices. Such coupling may include direct electrical connections, wireless connections, networked connections, etc., for implementing automatic control functions, remote control functions, and so on. The computer system 202 may be coupled via the bus 204 to an output device 214 (e.g., video display, liquid crystal display (LCD), light-emitting diode (LED) display, touchscreen display, voice synthesis hardware, voice synthesis software) for displaying and/or providing information to a computer user. The output device 214 may be controlled by a controller (e.g., display card, graphics card).

The computer system 202 includes input devices 216 (e.g., a keyboard, a cursor control, camera) for communicating information and command selections to processor 206. Such command selections can be implemented via voice recognition hardware and/or software functioning as the input devices 216. The cursor control, for example, may be a mouse, a trackball, cursor direction keys, touch screen display, optical character recognition hardware and/or software, etc., for communicating direction information and command selections to processor 206 and for controlling cursor movement on the output device 214. For example, a printer 218 may be coupled to the bus 204. The printer 218 is configured for providing printed listings of the data structures, information, etc., or any other data stored and/or generated by the computer system 202. The printer 218 may print the display 106.

The computer system 202 performs a portion or all of the processing steps of the techniques in response to processor 206 executing one or more sequences of one or more instructions contained in a memory, such as the main memory 208. Such instructions may be read into the main memory 208 from another computer-readable medium, such as storage device 212. One or more processors in a multi-processing arrangement may also be employed to execute the sequences of instructions contained in main memory 208. In alternative embodiments, hard-wired circuitry may be used in place of or in combination with software instructions. Thus, embodiments of the techniques and apparatuses are not limited to any specific combination of hardware circuitry and software.

As stated above, the computer system 202 includes at least one computer-readable medium (CRM) or memory programmed according to the teachings of the techniques and apparatuses for increasing the frequency of customer ratings and reviews of businesses online and for containing data structures, tables, records, or other data described herein. Stored on any one or a combination of CRM, the techniques and apparatuses for increasing the frequency of customer ratings and reviews of businesses online include software for controlling the computer system 202, for driving a device or devices for implementing the techniques and apparatuses, and for enabling the computer system 202 to interact with a human user. Such software may include, but is not limited to, device drivers, operating systems, development tools, and applications software. Such CRM further includes the computer program product for performing all or a portion (if processing is distributed) of the processing performed in implementing the techniques and apparatuses. The computer code devices may be any interpreted or executable code mechanism, including but not limited to scripts, interpreters, dynamic link libraries, Java classes, and complete executable programs. Moreover, parts of the processing of the present techniques and apparatuses may be distributed for better performance, reliability, and/or cost.

The term “computer-readable medium” (CRM), as used herein, refers to any medium that participates in providing instructions to processor 206 for execution. A CRM may take many forms, including but not limited to, non-volatile media, volatile media, and transmission media. Non-volatile media include, for example, optical, magnetic disks, and magneto-optical disks, such as storage device 212. Volatile media include dynamic memory, such as main memory 208. Transmission media include coaxial cables, copper wire, and fiber optics, including the wires that comprise bus 204. Transmission media also may also take the form of acoustic or light waves, such as those generated during radio wave and infrared data communications. Common forms of CRM include, for example, hard disks, floppy disks, tape, magneto-optical disks, PROMs (EPROM, EEPROM, Flash EPROM), DRAM, SRAM, SDRAM, or any other magnetic medium, compact discs (e.g., CD-ROM, DVD-ROM, BluRay disc) or any other optical medium, physical medium with patterns of holes, a carrier wave (described below), or any other medium from which a computer can read.

The computer system 202 may also include a communication interface 220 coupled to bus 204. Communication interface 220 provides a two-way data communication coupling to a network link 222 that may be connected to, for example, a network 224 (e.g., a local area network (LAN), wireless network). For example, communication interface 220 may be a network interface card attached to a packet switched LAN. As another example, communication interface 220 may be an asymmetrical digital subscriber line (ADSL) card, an integrated services digital network (ISDN) card, or a modem that provides a data communication connection to a corresponding type of telephone line. Wireless links may also be implemented via the communication interface 220. In any such implementation, communication interface 220 sends and receives electrical, electromagnetic, or optical signals that carry digital data streams representing various types of information.

Network link 222 typically provides data communication through one or more networks to other data devices. For example, network link 222 may provide a connection to a computer 226 through network 224, which provides communication services through communications network 112. The network 224 and communications network 112 may use electrical, electromagnetic, or optical signals that carry digital data streams. The signals through the various networks and the signals on network link 222 and through communication interface 220, which carry the digital data to and from computer system 202, are exemplary forms of carrier waves transporting the information. The computer system 202 can transmit notifications and receive data, including program code, through the network(s), network link 222, and communication interface 220.

The computer system 202 may also include a short-range communications system coupled to the bus 204 and configured to enable the computer system 202 to communicate with a radio tag 108 through a short-range communication protocol. For example, the short-range communications system may include a short-range communication subsystem 232 (e.g., NFC subsystem) coupled to the bus 204 and configured for communicating with a radio tag 108 (e.g., a passive NFC tag configured to be read by the computer system 202, a RFID tag) through a wireless link 238. The short-range communication subsystem 232 may be an NFC circuit. The short-range communication subsystem 232 may include a radio chip 234 (e.g., NFC chip) and an antenna 236. The short-range communication subsystem 232 may include a radio tag reader/writer functionality configured for reading data from and writing data to a radio tag 108.

In aspects, inductive coupling between the antenna 236 and an antenna of the radio tag 108 may enable the activation of a circuit of the radio tag 108. The radio tag 108 may include a data store configured to be read by the radio chip 324 using a communications protocol, for example, read by an NFC chip using an NFC communications protocol after an NFC circuit has been activated. The computer system 202 may include application software on the CRM that enables the computer system 202 to read the radio tag 108. For example, upon the customer placing the computer system 202 (e.g., second computing device 104) near the radio tag 108 or tapping the device 104 on the display 106 or radio tag 108, the circuit of the radio tag 108 may be activated. Upon activation of the circuit and the reading, by the computer system 202, of the radio tag 108, a programmed action is taken. For example, the computer system 202 accesses instructions stored within the data store of the radio tag 108, which results in the triggering of a function of the computer system 202. A function of the computer system 202 may include the opening of a web browser on the second computing device 104 and the web browser of the second computing device 104 utilizing the communications network 112 to cause a website served on a server computer 114 to be displayed on device 104 (e.g., in a web browser).

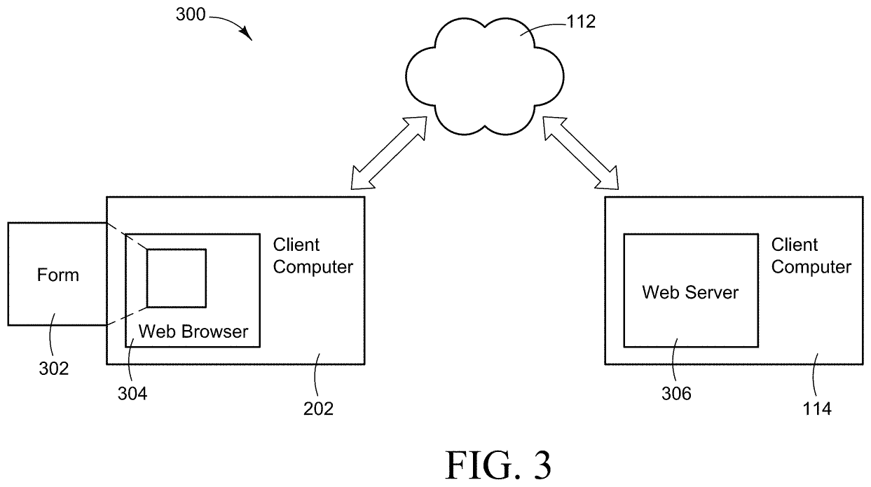

In aspects, the website displayed may be a website that presents a form to a customer for entering an online business review for a business. FIG. 3 illustrates an example environment 300 including a client computer system 202 (e.g., first computing device 102, second computing device 104) and a server computer 114, which may be utilized in techniques and apparatuses for increasing the frequency of customer ratings and reviews of businesses online. The client computer system 202 is connected to the server computer 114 via at least one communications network 112. One or more of the client computer system 202 or the server computer 114 may incorporate the elements of the computer system 202 as described in relation to FIG. 2. The form 302 in the web browser 304 may be used by a customer to enter form data (e.g., drop-down selection, radio button selection, star rating selection, textual input), and the form data is communicated via the communications network 112 to a web server 306 (e.g., a web server program) running on the server computer 114.

### Example Techniques and Apparatuses

The techniques and apparatuses for increasing the frequency of customer ratings and reviews of businesses online may be implemented on the computing system 202. The computing system 202 may include a service link generator representing functionality for determining or generating a service link (e.g., URL address, application programming interface (API) access) to an online business review submission page for a business in a particular online business review service. For example, the service link generator may determine that the service link for a business named ACME LLC is located at the URL address:

<<domain>>.com/company-id/acme_llc_0151341/online_business_review_entry.

The service link generator may be implemented on the CRM of the computing system 202. The service link generator may be remotely accessible to the computing system 202, for example, implemented on the CRM of computer 226 (e.g., a server computer). In some cases, the computing system 202 is configured to utilize the service link generator offered online at grade.us to determine a service link to the online business review submission page for a business.

The computing system 202 may include a short link generator (e.g., a URL address shortener, link shortener), representing functionality for generating a shortened URL address from an inputted URL address. The short link generator may be utilized to generate a shorter link to the online business review submission page generated by the service link generator, for example, shortening

<<domain>>.com/company-id/acme_llc_0151341/online_business_review_entry

to

<<domain>>.com/12475

to generate the short link URL address. The short link generator may be remotely accessible to the computing system 202, for example, implemented on the CRM of computer 226 (e.g., a server computer). The computing system 202 may be configured to utilize a web-based short link generating service to generate a shortened URL address for an online business review submission page for a business.

The display 106 may include a message service short code and a keyword prefix. The message service short code is a five-digit or six-digit phone number, also referred to as a Short Message Service (SMS) short code (or just “short code”). An SMS messaging platform may be utilized to generate the keyword prefix and/or the short code associated with the short link URL address. The short code and keyword prefix may be utilized in a message service message (e.g., an SMS message) sent by the customer to the computing system 202 requesting a reply message. The reply message (reply message service message) sent by the computing system 202 to the customer may include a short link URL address associated with one or more online business review submission pages. The message may be a Short Message Service (SMS) message, a Multimedia Messaging System (MMS) message, and the like.

The computing system 202 may associate the short link URL address, short code, and keyword prefix in a database. The database may be located on the CRM of the computing system 202 or may be remotely accessible to the computing system 202, for example, implemented on the CRM of computer 226 (e.g., a server computer).

The computing system 202 may include functionality (e.g., a code generator) for generating an optical machine-readable code 110 (e.g., a bar code, a QR code) from data. In an example, the data may be the short link URL address for an online business review submission page for a business generated by the short link generator, and the computing system 202 may generate an optical machine-readable code 110 (QR code) that includes data (e.g., an identifier) that points to the website indicated in the shortened URL address. In some cases, the code generator is a QR code generator. The code generator may be implemented on the CRM of the computing system 202. The code generator may be remotely accessible to the computing system 202, for example, implemented on the CRM of computer 226 (e.g., a server computer). In some cases, the computing system 202 is configured to utilize the QR code generating service offered at qr-code-generator.com as the code generator generating the optical machine-readable code 110. The generated optical machine-readable code 110 be incorporated into a display 106 displayed by the information display system 105, for example, utilizing the design platform described infra.

The computing system 202 may include a design platform. In aspects, the design platform is utilized to design the display 106 to be displayed on or in connection with the information display system 105. The display 106 may include indicia representing one or more of textual material, graphical material, a keyword prefix, a short code, a barcode. In some cases, the indicia on the display 106 includes a short link URL address generated by the short link generator. In some cases, the display 106 includes a message service short code and a keyword prefix. In some cases, the display 106 includes a machine-readable code (e.g., a QR code, a barcode). In some cases, at least one of the display 106 or the information display system 105 includes a radio tag 108 (e.g., an NFC tag). The design platform may be implemented on the CRM of the computing system 202, for example, a graphics editor software package installed on the computing system. The design platform may be remotely accessible to the computing system 202, for example, implemented on the CRM of computer 226 (e.g., a server computer).

The computing system 202 may include a short message service (SMS) delivery platform, representing functionality for sending and receiving SMS messages. SMS is a text messaging service component of most telephone, Internet, and mobile device systems that uses standardized communication protocols to enable computing devices (e.g., mobile devices) to exchange short text messages (SMS messages). The SMS delivery platform may be implemented on the CRM of the computing system 202. The SMS delivery platform may be remotely accessible to the computing system 202, for example, implemented on the CRM of computer 226 (e.g., a server computer). In some cases, the SMS delivery platform may be the MOBIT platform (mobit.com).

In aspects, a customer sends a message (e.g., SMS message) to a message service short code that includes a keyword prefix. For example, the customer may send an SMS message of “review” (the keyword prefix) to the short code of 55555. The computer system 202 (e.g., an SMS delivery platform implemented on the CRM of the computer system 202) receives the message, including the short code and keyword prefix sent by the customer. Responsive to receiving the SMS message and keyword prefix, the computer system 202 utilizes the database to determine a short link URL address (e.g., a short link URL address generated by the short link generator) associated with the keyword prefix and sends a reply SMS message to the customer that includes the associated short link URL address. The customer receives the reply SMS message, including the short link URL address, for example, on the customer's computing device (e.g., mobile phone). Once the customer clicks on the short link URL address, for example, in the customer's text messaging application, the customer's computing device loads the web page associated with the short link URL address. The web page may be associated with one or more online business review submission pages for one or more online business review services, enabling the customer to leave an online business review.

One or more of the information display system 105 and the display 106 can be utilized to display information to a customer. For example, the information display system 105 may be a display rack, table tent, display holder, digital display (e.g., digital screen), printed display, framed display, printed information, digital information, and the like. The display 106 may include one or more of an optical machine-readable code 110 and keyword prefixes/short codes for SMS that allow a customer to conveniently access content libraries, linked Portable Document Format (pdf) files, landing pages/website URL addresses, and the like.

In aspects, the customer utilizes a computer system 202 (e.g., smartphone) to initiate the customer rating and review at the display 106. The computer system 202 may be an NFC-enabled smartphone of the customer and/or a smartphone of the customer, including a camera as an input device 216. The camera is preferably configured for connection with a barcode application implemented on the CRM of the computer system 202. The use of “barcode application” herein means an application that is able to decode optical, machine-readable representations of data (e.g., a barcode, a linear barcode, a matrix (2D) barcode). One example of a matrix barcode is a QR code. The barcode application may be the default camera application on the computing device or may be a separate barcode-reader application installed on the CRM of the computer system 202.

In use, after receiving a service and/or goods, a customer can utilize the display 106, through use of one or more of the optical machine-readable code 110 (e.g., barcode, QR code), radio tag 108, or by sending an SMS message utilizing the short code and prefix, to leave a customer rating and review of the business online. In one example, the customer can leave an online business review for the business by, in a text messaging application on the customer's computing device, typing in a keyword prefix and sending it to the short code. The system may then respond with an SMS, including a shortened link to the online business review submission page for further input by the customer. In another example, the customer places their NFC-enabled computing device near a target area, the computing device recognizes the presence of the NFC tag, and a link to the online business review submission page for further input by the customer is received by the customer. In an additional example, the customer opens a QR code reader application on the customer's computing device, the customer scans the QR code with the computing device, and a link arrives through a QR-reader-enabled application on the customer's computing device. In a further example, upon at least one of these triggers, the customer taps the received link, and if the customer has an online business review account already set up, then the customer arrives on the review page and can simply tap a number of stars (or other indicia) reflecting their experience and/or can optionally include a written review. In yet a further example, after creating the review, the customer can tap a “Submit,” “Post,” or the like button and has left a review for the business online

### Example Methods

This section describes example methods, which may operate separately or together, in whole or in part. The methods are illustrated as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods (e.g., method 400, method 500, method 600). In portions of the following discussion, reference may be made to the example operating environments 100 of FIG. 1, 200 of FIG. 2, or 300 of FIG. 3, or to entities or processes described elsewhere in this disclosure and as detailed in other figures, reference to which is made for example only. The techniques are not limited to performance by one entity or multiple entities operating on one device. The method as illustrated in these figures may take place either as a series of steps in a stored program run on the computing device, server computer, or on another computer, and any or all portions of this method may instead be performed manually by another entity. The server computer 114 (e.g., the operator of an online business review service) may display the form data input by the customer on a website (e.g., a website hosted on the server computer 114). For example, the server computer may provide a website relating to online business reviews, and the form data input by the customer may be an online business review for a business.

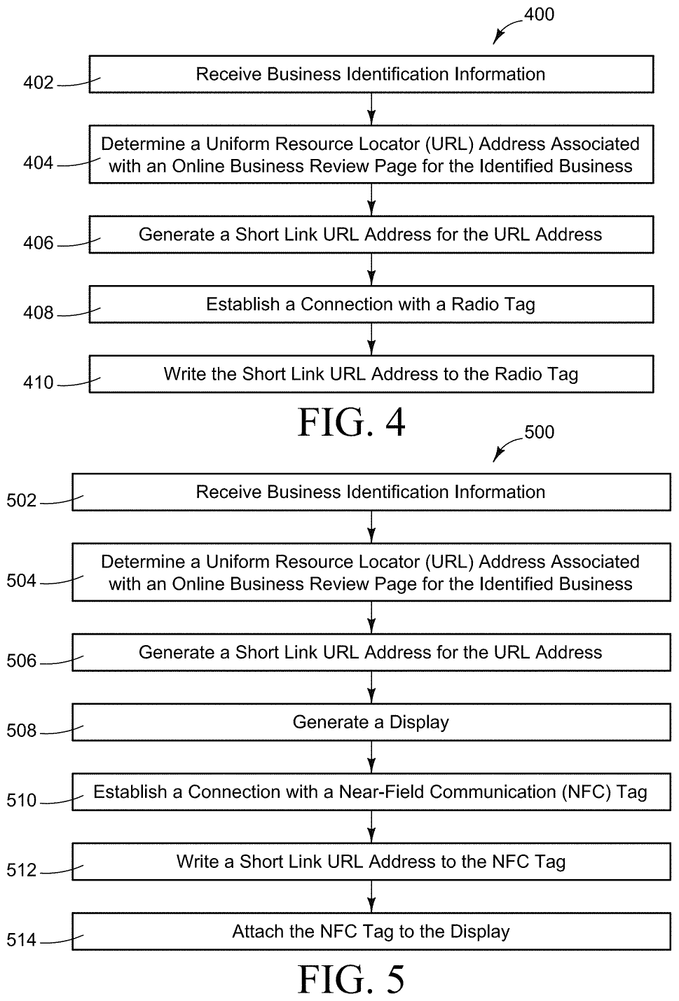

FIG. 4 illustrates example method 400, implemented by a computing device, for increasing the frequency of customer ratings and reviews of businesses online. At 402, business identification information identifying a business is received. The business identification information may include one or more of a business address or a business location. The business identification information, or aspects thereof, may be determined by receiving the information from a customer or from a third-party, such as the business or an online business review service provider. At 404, utilizing the business identification information, a URL address associated with an online business review page for the identified business is determined. The URL address may be a direct link to an online business review page (e.g., a star rating page, online business review submission page). The identified URL address may be modified, for example, to include a place identifier associated with the business and/or an additional URL segment to create a direct link to an online business review page for the business. As described supra, an API may be utilized to determine a place identifier associated with the business. At 406, a short link URL address for the URL address is generated. The short link URL address may be generated utilizing the short link generator of the computing system 202, described supra. At 408, a connection is established with a radio tag, and at 412 the short link URL address is written to the radio tag.

FIG. 5 illustrates example method 500, implemented by a computing device, for increasing the frequency of customer ratings and reviews of businesses online. At 502, business identification information is received. The business identification information may identify a business. At 504, utilizing the business identification information, a URL address associated with an online business review page for the identified business is determined. The URL address may be a direct link to an online business review page (e.g., a star rating page, online business review submission page). At 506, a short link URL address for the URL address is generated, for example, utilizing a short link generator, as described supra. At 508, a display (e.g., display 106) is generated, for example, utilizing the design platform of the computing system 202, described supra. At 510, a connection with an NFC tag is established. At 512, the short link URL address is written to the NFC tag. At 514, the NFC tag is attached to the display.

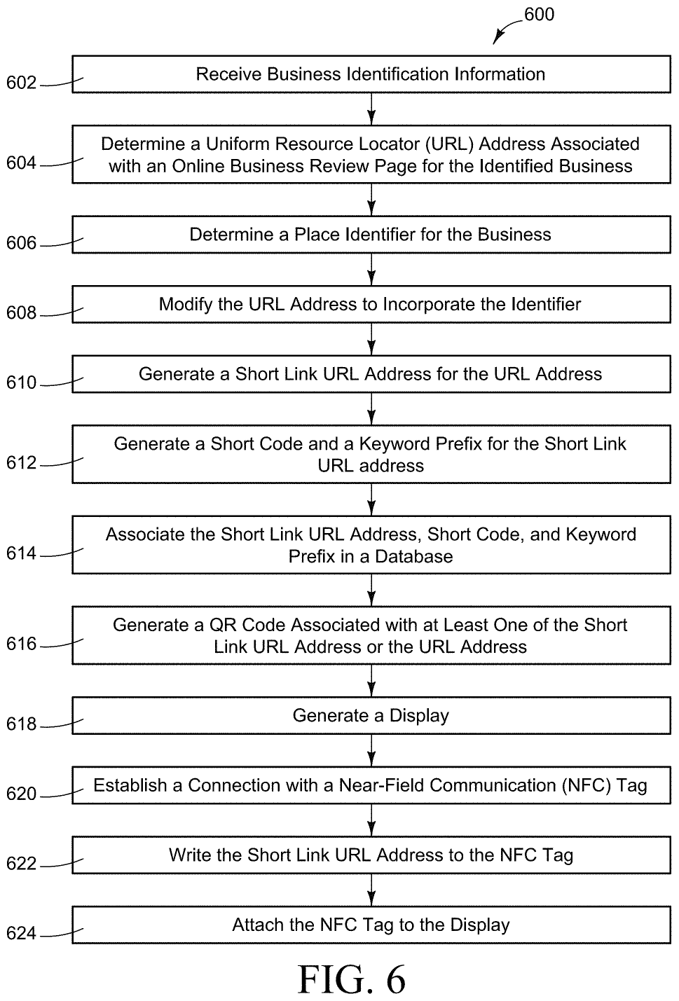

FIG. 6 illustrates an example method 600, implemented by a computing device, for increasing the frequency of customer ratings and reviews of businesses online. At 602, business identification information is received. The business identification information may identify a business. At 604, utilizing the business identification information, a URL address associated with an online business review page for the identified business is determined. The URL address may be a direct link to an online business review page (e.g., a star rating page, online business review submission page). At 606, a place identifier for the business is determined. At 608, utilizing the business identification information and place identifier, a URL address associated with an online business review page for the identified business is determined. The URL address may be a direct link to an online business review page (e.g., a star rating page, online business review submission page). At 610, a short link URL address for the URL address is generated, for example, utilizing a short link generator, as described supra. At 612, a short code and keyword prefix for the short link URL address is generated, and at 614, the short link URL address, short code, and keyword prefix are associated in a database. At 616, a QR code associated with at least one of the short link URL address or the URL address is generated. At 618, a display (e.g., display 106) is generated, for example, utilizing the design platform of the computing system 202, described supra. At 620, a connection with an NFC tag is established. At 622, the short link URL address is written to the NFC tag. At 624, the NFC tag is attached to the display.

The use of “e.g.,” “etc.,” “for instance,” “in example,” “for example,” “or,” and grammatically related terms indicates non-exclusive alternatives without limitation, unless otherwise noted. The use of “including” and grammatically related terms means “including, but not limited to,” unless otherwise noted. The use of the articles “a,” “an,” and “the” are meant to be interpreted as referring to the singular as well as the plural, unless the context clearly dictates otherwise. Thus, for example, reference to “a review” includes two or more such reviews and the like. The use of “optionally,” “alternatively,” and grammatically related terms means that the subsequently described element, event, or circumstance may or may not be present/occur and that the description includes instances where said element, event, or circumstance occurs and instances where it does not. The use of “preferred,” “preferably,” and grammatically related terms means that a specified element or technique is more acceptable than another, but not that such specified element or technique is a necessity, unless the context clearly dictates otherwise. The use of “exemplary” means “an example of” and is not intended to convey the meaning of an ideal or preferred embodiment. As used herein, a phrase referring to “at least one of” a list of items refers to any combination of those items, including single members. For example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

### ADDITIONAL EXAMPLES

In the following section, additional examples are provided.

Example 1. A computer-implemented method of increasing the frequency of customer rating and review of businesses online, the method comprising: receiving a business information for a business; determining a link to an online business review portal; determining a place identifier for the business; creating a direct link based on the link to the online business review and place identifier; applying a URL address shortener to the direct link to form a short link URL address; creating a barcode using the short link URL address; and generating a display including the barcode; and presenting the display to a customer.

Example 2. A method of increasing the frequency of customer rating and review of businesses online, the method comprising: acquiring a link to an online business review; finding a place identifier; creating a direct link based on the link to the online business review and place identifier; applying a URL address shortener to the direct link to form a short link URL address; generating a short code for the short link URL address; creating a keyword to summon link; generating a display including the keyword and short code; and presenting the display to a customer.

Example 3. A method of increasing the frequency of customer rating and review, the method comprising: acquiring a link to an online business review; creating a barcode using the link; generating a display including the barcode; and presenting the display to a customer.

Example 4. A method of increasing the frequency of customer rating and review, the method comprising: acquiring a link to an online business review; finding a place identifier; creating a direct link based on the link to the online business review and place identifier; applying a URL address shortener to the direct link to form a short link URL address; programming an NFC tag with the short link URL address; attaching the NFC tag to a display; and presenting the display to a customer.

Example 5. A method implemented by a computing device comprising: receiving, by a computing device, business identification information, the business identification information identifying a business; determining, utilizing the business identification information, a Uniform Resource Locator (URL) address associated with an online business review page for the identified business; generating a short link URL address for the URL address, the short link URL address shorter than the URL address; and generating a display.

Example 6. A method implemented by a computing device comprising: receiving, by a computing device, business identification information, the business identification information identifying a business; determining, utilizing the business identification information, a Uniform Resource Locator (URL) address associated with an online business review page for the identified business; generating a short link URL address for the URL address, the short link URL address shorter than the URL address; generating a short code and a keyword prefix for the short link URL address; associating the short link URL address, short code, and keyword prefix in a database; and generating a display, the display including the keyword prefix and the short code.

Example 7. A method implemented by a computing device comprising: receiving business identification information, the business identification information identifying a business; determining, utilizing the business identification information, a Uniform Resource Locator (URL) address associated with an online business review page for the identified business; generating a short link URL address for the URL address, the short link URL address shorter than the URL address; establishing a connection with a radio tag; and writing the short link URL address to the radio tag.

Example 8. A method implemented by a computing device comprising: receiving business identification information, the business identification information identifying a business; determining, utilizing the business identification information, a Uniform Resource Locator (URL) address associated with an online business review page for the identified business; generating a short link URL address for the URL address, the short link URL address shorter than the URL address; generating a display; establishing a connection with a near-field communication (NFC) tag; writing the short link URL address to the NFC tag; and attaching the NFC tag to the display.

Example 9. A method implemented by a computing device comprising: receiving business identification information, the business identification information identifying a business; determining, utilizing the business identification information, a Uniform Resource Locator (URL) address associated with an online business review page for the identified business, wherein determining the URL address associated with an online business review page for the identified business further comprises: determining a place identifier for the business; and modifying the URL address to incorporate the identifier; generating a short link URL address for the URL address, the short link URL address shorter than the URL address; generating a short code and a keyword prefix for the short link URL address; associating the short link URL address, short code, and keyword prefix in a database; generating an optical machine-readable code associated with at least one of the short link URL address or the URL address, wherein the generated optical machine-readable code comprises a QR code; generating a display, wherein generating the display comprises including indicia representing the keyword prefix, the short code, and the QR code on the display; establishing a connection with a near-field communication (NFC) tag; writing the short link URL address to the NFC tag; and attaching the NFC tag to the display.

### CONCLUSION

The foregoing detailed description provides exemplary embodiments of the disclosed techniques and apparatuses for increasing the frequency of customer ratings and reviews of businesses online. The description and illustration of these embodiments are intended only to provide examples of the techniques and apparatuses, and not to limit the scope of the techniques and apparatuses, or their protection, in any manner.

What is claimed is:

1. A method implemented by a computing device comprising:
receiving business identification information, the business identification information identifying a business;
determining, utilizing the business identification information, a Uniform Resource Locator (URL) address associated with an online business review page for the identified business;
generating a short link URL address for the URL address, the short link URL address shorter than the URL address;
establishing a connection with a radio tag; and
writing the short link URL address to the radio tag.

2. The method of claim 1, wherein the radio tag is a near-field communication tag.

3. The method of claim 1, further comprising:
generating a display; and
attaching the radio tag to the display.

4. The method of claim 3, wherein generating the display comprises:
printing a document.

5. The method of claim 3, wherein generating the display comprises:
displaying the display on an output device.

6. The method of claim 3, further comprising:
generating a short code and a keyword prefix for the short link URL address; and
associating the short link URL address, short code, and keyword prefix in a database,
wherein generating the display comprises including indicia representing the keyword prefix and the short code on the display.

7. The method of claim 6, further comprising:
receiving a message service message including the short code and the keyword prefix from a customer;
determining, from the database, the short link URL address associated with the short code and the keyword prefix; and
sending a reply message service message to the customer, the reply message service message including the short link URL address.

8. The method of claim 3, further comprising:
generating an optical machine-readable code associated with at least one of the short link URL address or the URL address,
wherein generating the display further comprises including the generated optical machine-readable code in the display.

9. The method of claim 8, wherein the generated optical machine-readable code comprises a QR code.

10. The method of claim 1, wherein the business identification information further identifies a business location.

11. The method of claim 1, wherein determining the URL address associated with an online business review page for the identified business further comprises:
determining an identifier for the business.

12. The method of claim 11, wherein determining the URL address associated with an online business review page for the identified business further comprises:
modifying the URL address to incorporate the identifier.

13. The method of claim 12, wherein the identifier is a place identifier.

14. A method implemented by a computing device comprising:
receiving business identification information, the business identification information identifying a business;
determining, utilizing the business identification information, a Uniform Resource Locator (URL) address associated with an online business review page for the identified business;
generating a short link URL address for the URL address, the short link URL address shorter than the URL address;
generating a printed display;
establishing a connection with a near-field communication (NFC) tag;
writing the short link URL address to the NFC tag; and
attaching the NFC tag to the printed display.

15. The method of claim 14, wherein the business identification information further identifies a business location.

16. The method of claim 14, wherein determining the URL address associated with an online business review page for the identified business further comprises:
determining a place identifier for the business; and
modifying the URL address to incorporate the identifier.

17. The method of claim 14, further comprising:
generating a short code and a keyword prefix for the short link URL address,
wherein generating the printed display comprises including indicia representing the keyword prefix and the short code on the printed display.

18. The method of claim 17, further comprising:
associating the short link URL address, short code, and keyword prefix in a database.

19. The method of claim 18, further comprising:
receiving a message service message including the short code and the keyword prefix from a customer;
determining, from the database, the short link URL address associated with the short code and the keyword prefix; and
sending a reply message service message to the customer, the reply message service message including the short link URL address.

20. A method implemented by a computing device comprising:
receiving business identification information, the business identification information identifying a business;
determining, utilizing the business identification information, a Uniform Resource Locator (URL) address associated with an online business review page for the identified business by:
determining a place identifier for the business; and
modifying the URL address to incorporate the identifier;
generating a short link URL address for the URL address, the short link URL address shorter than the URL address;
generating a short code and a keyword prefix for the short link URL address;
associating the short link URL address, short code, and keyword prefix in a database;
generating an optical machine-readable code associated with at least one of the short link URL address or the URL address, the generated optical machine-readable code comprising a QR code;
generating a printed display, the printed display comprising indicia representing the keyword prefix, the short code, and the QR code on the printed display;
establishing a connection with a near-field communication (NFC) tag;
writing the short link URL address to the NFC tag; and
attaching the NFC tag to the display.
